(19) United States
(12) Patent Application Publication
(10) Pub. No.: US 2016/0246921 A1
(43) Pub. Date: Aug. 25, 2016

(54) MULTI-SAMPLE DIFFERENTIAL VARIATION DETECTION

(71) Applicant: Spiral Genetics, Inc., Seattle, WA (US)

(72) Inventors: Jeremy Joseph Bruestle, Bellevue, WA (US); Becky L. Drees, Seattle, WA (US)

(21) Appl. No.: 14/631,791

(22) Filed: Feb. 25, 2015

(51) Int. Cl. G06F 19/22; G06F 19/16

(52) U.S. Cl. CPC G06F 19/22; G06F 19/16

(57) ABSTRACT

DNA assembly techniques for a DNA dataset comprised of DNA sequence reads make use of anchor points identified using a reference DNA sequence. Because the anchor point technique is dependent on a high accuracy dataset, related techniques to detect erroneous reads and to correct erroneous reads making use of k-Mer and statistical techniques are also disclosed. Upon preparing a high accuracy dataset, a read overlap graph is generated that removes exact matches with respect to the reference DNA sequence, thereby leaving behind potential structural variants. Using anchor points representing closed matches to the reference DNA dataset, the read overlap graph is traversed to detect potential structural variants. The structural variants are then validated. Use cases for anchor assembly and related techniques, including multi-sample differential variant detection are also disclosed.

### BACKGROUND

In Deoxyribonucleic Acid (“DNA”) sequencing, Next Generation Sequencing (“NGS”) techniques seek to detect patterns in a subject's DNA that correspond to medical/physiological conditions in the subject. Generally, if a pattern is well known, a DNA sequence may be traversed using conventional techniques to search for a particular pattern. However, since sequencing typically seeks abnormal conditions, the patterns sought are typically variations on standard DNA strands, called structural variants (“SVs”).

In practice, DNA sequences are reconstructed from sub-strands of DNA (called “reads”) taken from samples. The reconstruction involves reassembling the reads into the original DNA sequence. Thus if the reassembly of the DNA sequence is incorrect, then patterns affected by those errors cannot be reliably detected. In particular, NGS techniques may use either a reference genome sequence as a scaffold to map the reads during reassembly, or the reads may be mapped to overlapping portions of other reads without a reference sequence (called “de novo” sequencing).

DNA sequences comprise a sequence of base pairs corresponding to the four nucleic acids, adenine, thymine, cytosine, and guanine (abbreviated A, T C, G respectively). In NGS, reads are mapped to the reference sequence by matching long, non-repeating sequences of base pairs in the read, to base pair sequences in the reference sequence. However, reference sequences are unlikely to have hitherto undetected structural variants. Accordingly, use of conventional NGS techniques with reference sequences are unlikely to provide the basis to reassemble reads in such a way to detect structural variants.

The problem is exacerbated by structural variants that are particularly large and complex. If a structural variant is longer than the distance between two mapping points on a reference sequence, then mapping to the reference sequence will lose the information in those large and complex structural variants in the DNA reads to be reassembled.

Conventional NGS techniques also include de novo sequencing which avoids the use of a reference sequence scaffold. Specifically, de novo sequences involve searches for overlaps of base pair subsequences in reads, and align the reads where a significant overlap is detected.

However, the larger the SV to be detected, the longer the sequences to be reassembled, and the larger the combinatorial permutations of de novo sequencing become. For this reason, de novo sequencing is generally considered prohibitively expensive and impractical to detect large sequences. In fact, a literature search of de novo sequencing yields a strong bias towards the analysis of relatively small sequences, leaving SV analysis wanting.

Yet large SVs are both frequent and significant. Large SVs are generally 50 base pairs or more in size. In humans, a random pair of genomes will contain 2-4 million base pairs of variation in the form of insertions and deletions of more than 100 base pairs. One out of 7,000 newborns is likely to be born with a condition related to a large SV. Large SVs have been linked to complex disorders such as Crohn's Disease, rheumatoid arthritis, and diabetes.

Large SVs are also significant aside from human medical conditions. Large SVs are linked to phenotypic variations of maize, barley, and rice, including variations relating to resistance to environmental stressors and threats.

Accordingly, there is a need for improve techniques to detect SVs with complexity greater than detectable via conventional reference sequencing techniques and/or detectable within reasonable cost and computation time via de novo techniques.

Additionally, there is a need to apply SV detection techniques to bioinformatics use cases, such as the detection of SVs that are not in a first DNA sample, but are in a second DNA sample.

### BRIEF DESCRIPTION OF THE DRAWINGS

The Detailed Description is set forth with reference to the accompanying figures.

FIG. 1 is a top level diagram of Anchored Assembly.

FIG. 2 is a diagram of an exemplary hardware, software and communications environment for Anchored Assembly.

FIG. 3 is a flow chart for an exemplary process to separate true reads from erroneous reads.

FIG. 4 is a frequency distribution chart in the context of an exemplary process to separate true reads from erroneous reads.

FIG. 5 is a diagram of k-Mers in the context of an exemplary process to correct erroneous reads.

FIG. 6 is a flow chart of an exemplary process to correct erroneous reads.

FIG. 7 is a graph showing an exemplary determination of weights.

FIG. 8 is a graph showing an exemplary determination of anchor points and performance of Anchored Assembly.

FIG. 9 is a flow chart of an exemplary process perform Anchored Assembly.

FIG. 10 is an illustration of an exemplary process in which the detection of variation difference in multiple samples is performed.

FIG. 11 is a flow chart of an exemplary process to detect variation differences in multiple samples.

### DETAILED DESCRIPTION

### Context of Anchored Assembly

### Overview

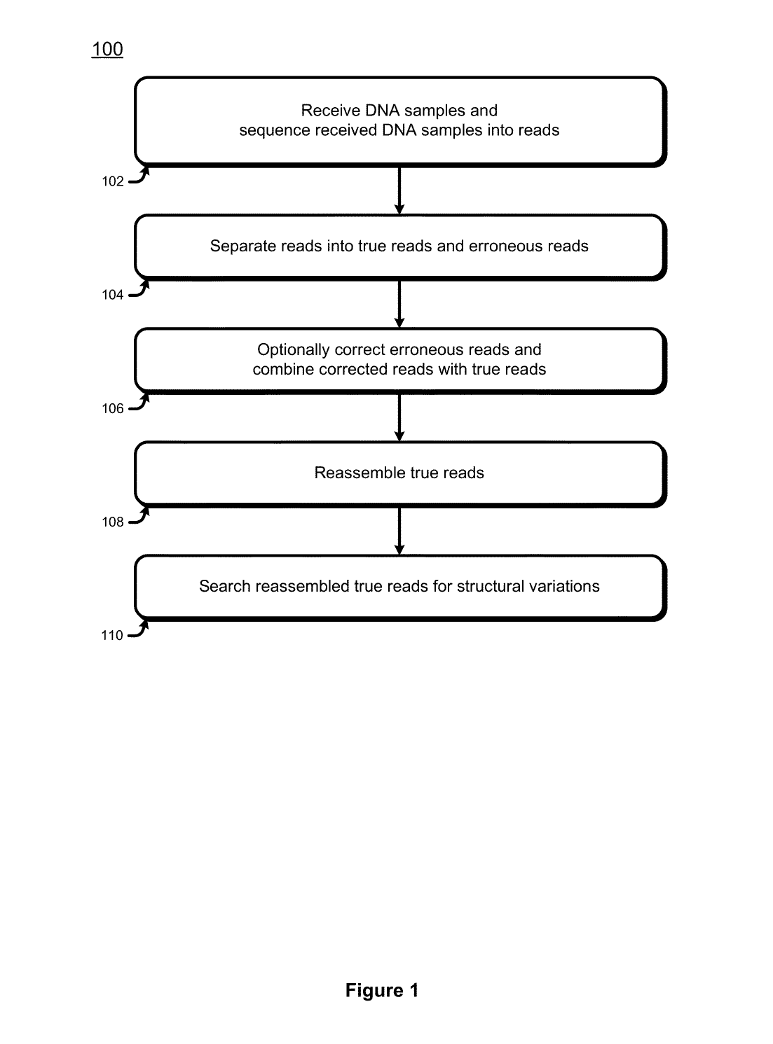

DNA sequencing comprises receiving a DNA sample, reading the DNA sub-strands (called “reads”), and reassembling the reads in the original DNA sample. However, the DNA sequencing process is subject to a number of points where errors may be introduced. Techniques to reduce those errors, and in particular to detect structural variants (“SVs”) with confidence are disclosed. FIG. 1 is an overview diagram 100 of those techniques.

In block 102, a DNA sample is received and sequenced into a dataset of reads. The DNA sample generally has multiple instances of chromosomes, thus the reads will contain redundancies that allow for the use of statistical techniques.

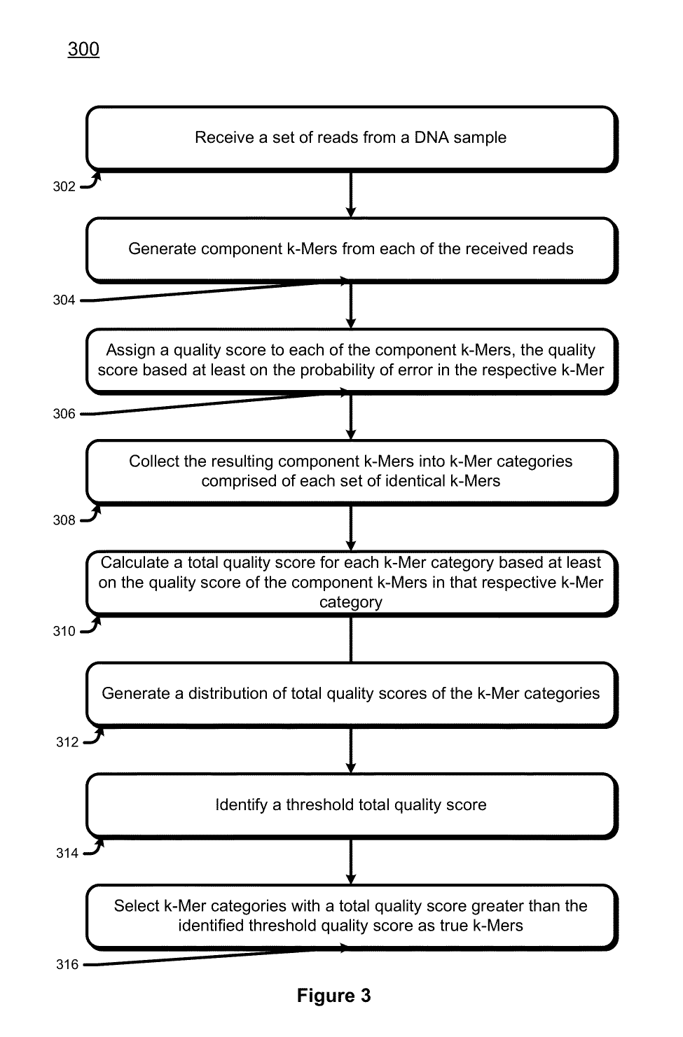

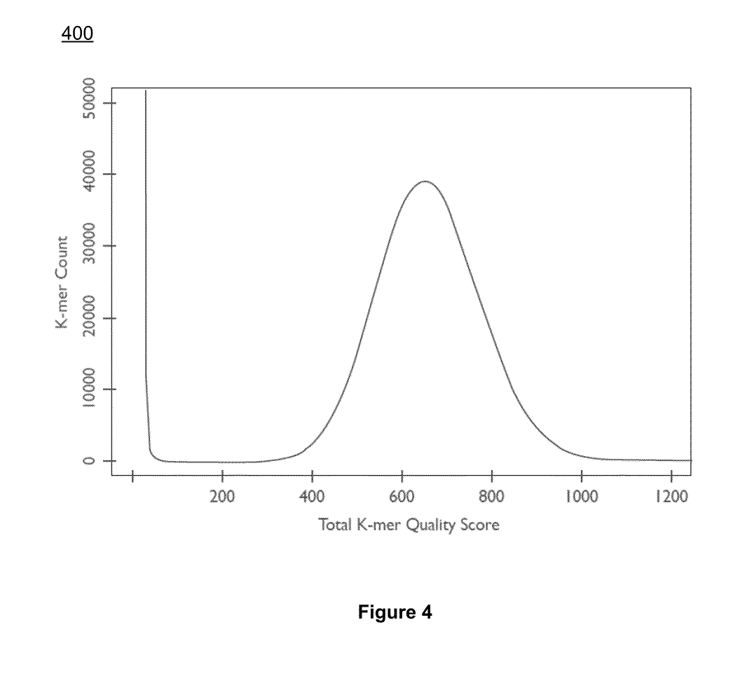

The DNA reading process is inexact. As a result, the DNA reads may contain errors. Furthermore, the DNA reads generally are not of a complete chromosome, but rather are fragments. Since reassembling the fragments rely on matching base pair sequences, an error in the read will cause a match to be made, thereby introducing an error. In block 104, the reads are separated into true reads, or reads likely not to contain errors, and erroneous reads, or reads likely to contain errors. Use of statistical techniques to separate true reads from erroneous reads are disclosed with respect to FIGS. 3 and 4.

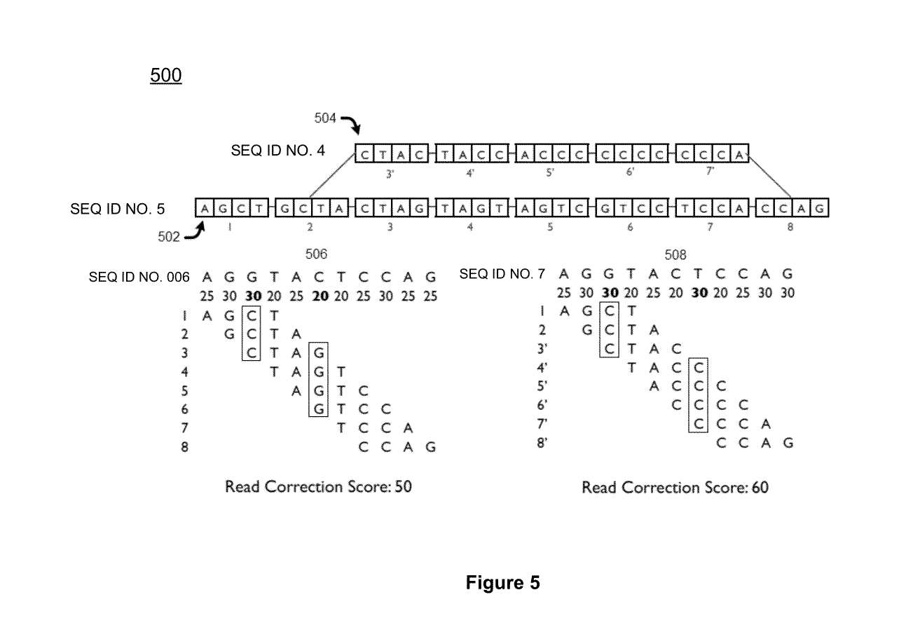

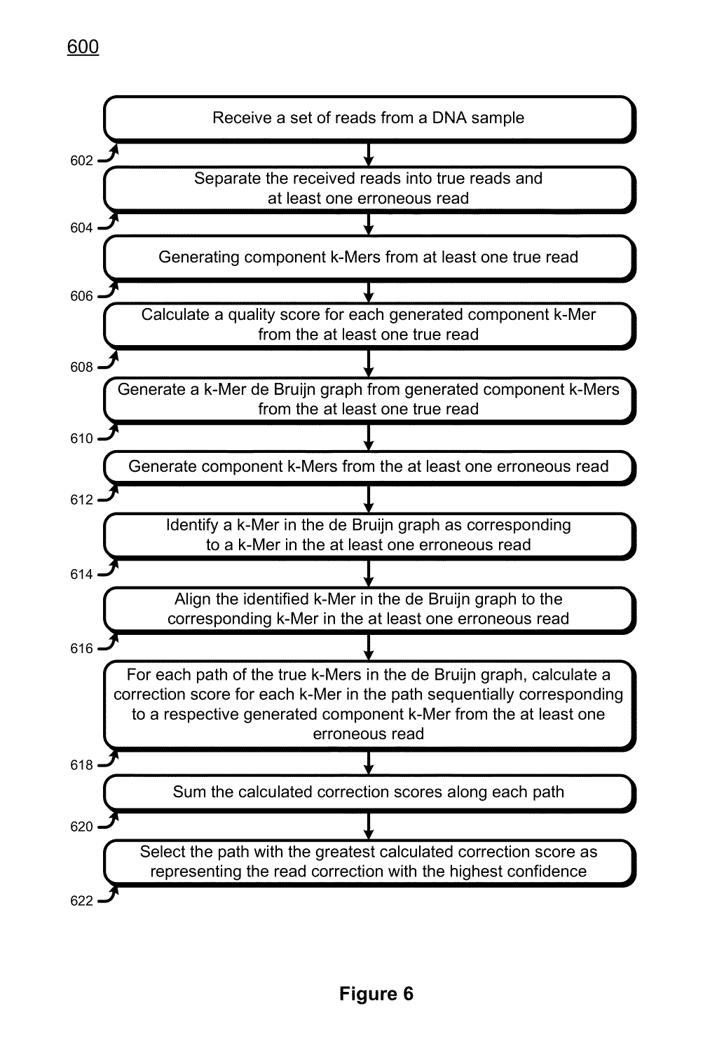

While some DNA reassembly may be performed using a subset of the original DNA sample, often it is desirable to correct erroneous reads. In block 106, erroneous reads are corrected and reintroduced to the set of true reads. Techniques to correct erroneous reads are disclosed with respect to FIGS. 5 and 6.

In block 108, the true reads are then reassembled. In the techniques disclosed herein, the reassembled DNA sequence is represented as a graph of reads. The different paths in the graph represent potential structural variants. In order to reduce the combinatorial permutations in the graph, the graph of reads is limited to reads that do not have an exact match with a reference sequence. In this way, the permutations that correspond to non-structural variants are eliminated thereby reducing the permutations to be analyzed and improving computing performance.

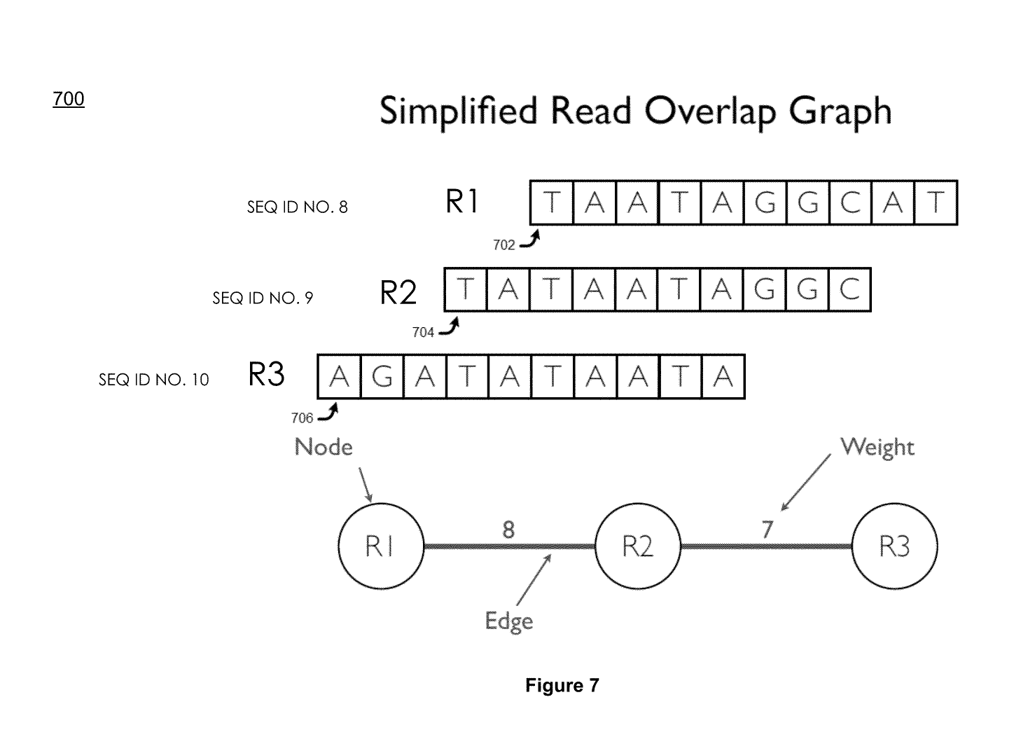

In block 110, the reassembled DNA sequence is then searched for potential structural variations. In the techniques disclosed herein, anchor points are used to simplify the detection of structural variants. The detection of anchor points and the performance of Anchored Assembly to detect structural variants are disclosed with respect to FIGS. 7, 8 and 9.

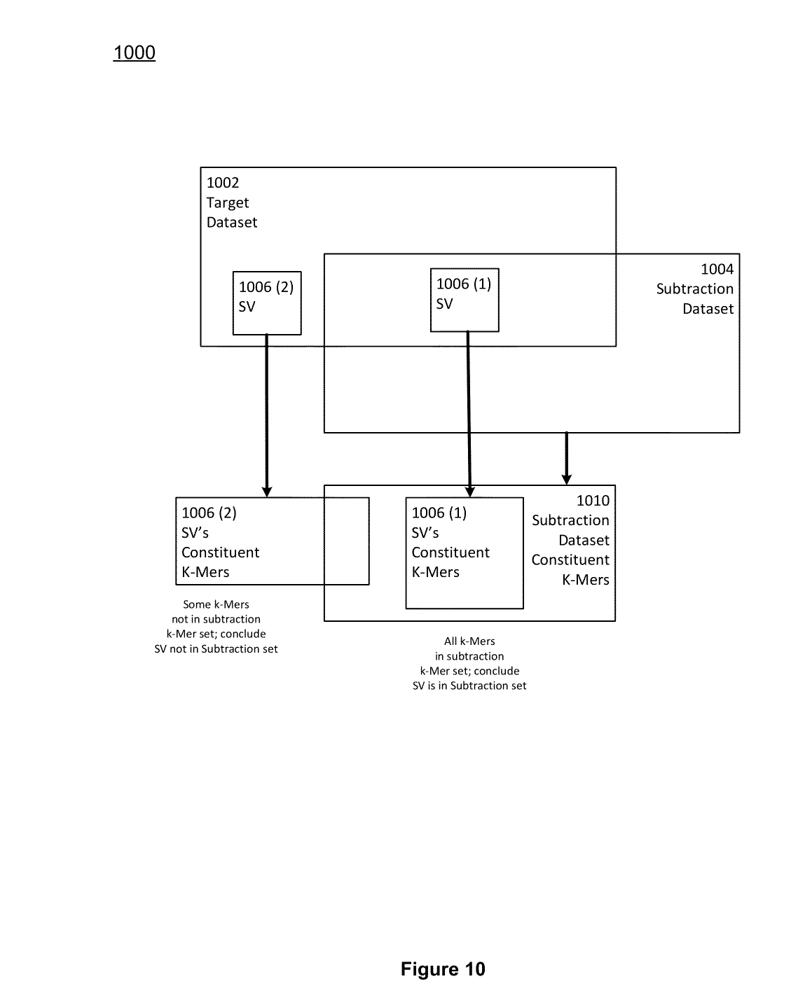

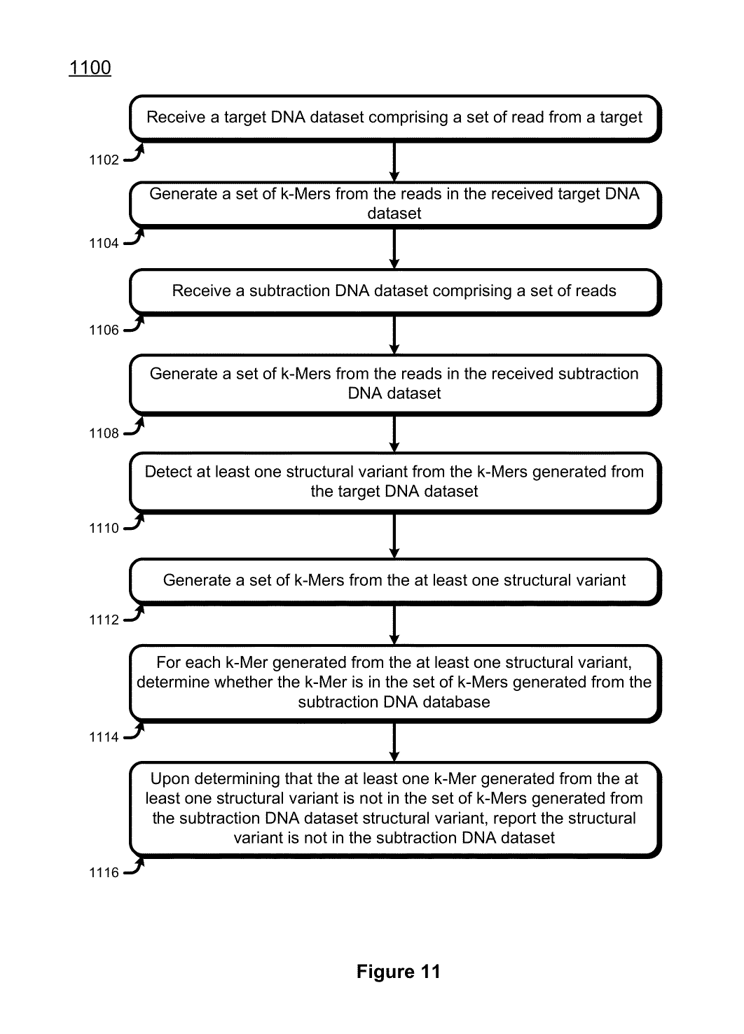

Anchored Assembly and the other techniques disclosed herein may be used in a wide variety of use cases. One exemplary use case is the efficient detection of structural variants in a target DNA dataset that are not in another DNA dataset (“subtraction dataset”). Use of Anchored Assembly and the other techniques disclosed herein are disclosed with respect to FIGS. 10 and 11.

### K-Mers and K-Merization

The terms k-Mer and k-Merization are use throughout this disclosure. A k-Mer is a substring of length k, of a string, wherein the substring preserves the sequence of the characters composing the string. For example, the string ABCDEFG, includes BCDE and DEFG as 4-Mers.

K-Merization is the generation of all k-Mers of length k of a string. Turning to our original example of ABCDEFG, a k-Merization of length 4 would yield the 4-Mers ABCD, BCDE, CDEF, DEFG. When a string has been subjected to a k-Merization, the string is said to have been k-Merized.

In the case of DNA sequencing, base pairs are typically indicated as strings of the letters ATCG, standing for the four constituent nucleic acids, adenine, thymine, cytosine and guanine. Accordingly, DNA sequences may be represented as strings. For example, CTTCAGGTCCATATG would represent 15 base pairs composing the DNA sequence. Thus, a read may be represented as a text string, and may be k-Merized by generating all of its constituent k-Mers.

K-Mers and k-Merization are particularly helpful in DNA sequencing since analysis of the k-Mers of a DNA sequence may be used to simplify or optimize computational analysis.

### Exemplary Hardware, Software and Communications Environment

### Computing Device

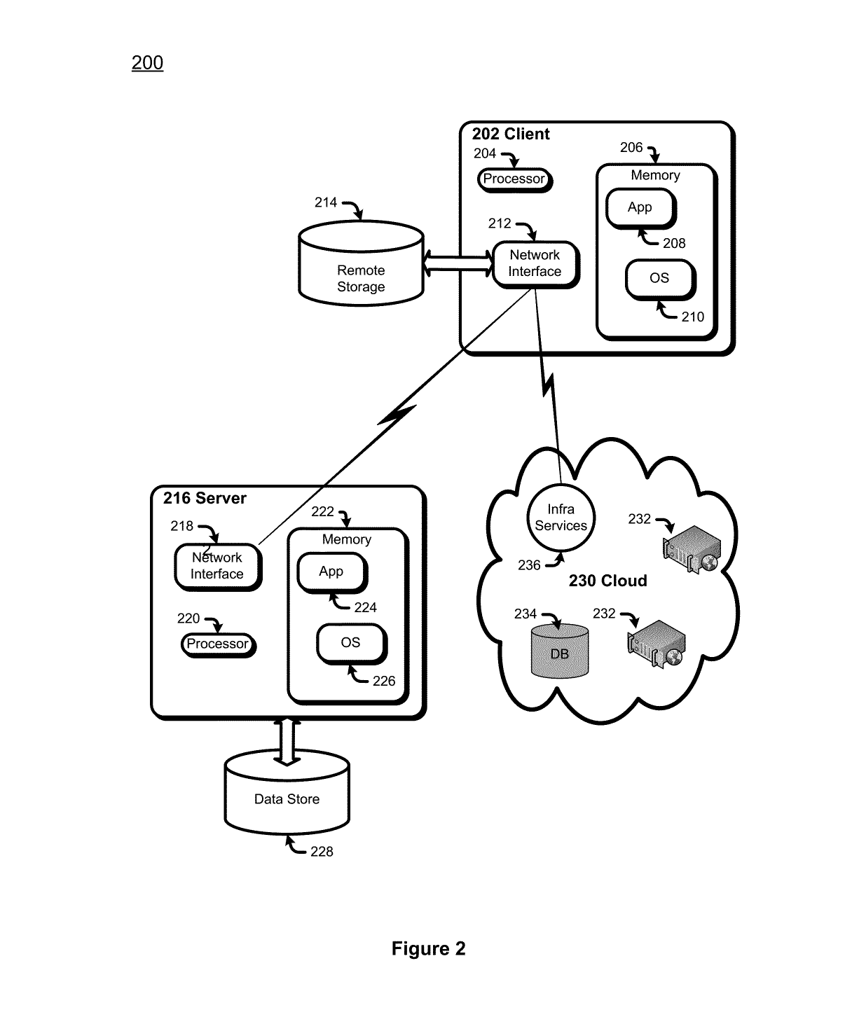

Prior to disclosing Anchored Assembly and related techniques, an exemplary hardware, software and communications environment is disclosed. FIG. 2 illustrates several possible embodiments of a hardware, software and communications environment 200 for Anchored Assembly and related techniques.

Client device 202 is any computing device. Exemplary computing devices include without limitation personal computers, tablet computers, smart phones, and smart televisions and/or media players.

Anchored Assembly and related techniques may be used in a number of platform contexts. Although Anchored Assembly and related techniques may be brought to bear on a typical networked client device 202 accessing a remote server, Anchored Assembly and related techniques alternatively may be implemented on a standalone computer. Accordingly, those techniques might be performed on a client device 202 that is a portable laptop, or a portable embedded system, or a standalone stations such as a kiosk. For example, a researcher in the field may have a custom computing device that contains an integrated computer to perform Anchored Assembly and related techniques. Alternatively, a research lab may have an enclosed station that also contains an integrated computer to perform Anchored Assembly and related techniques.

A client device 202 may have a processor 204 and a memory 206. Client device 202's memory 206 is any computer-readable media which may store several software components including an application 208 and/or an operating system 210. In general, a software component is a set of computer executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

To participate in a communications environment, user equipment device 202 may have a network interface 212. The network interface 212 may be one or more network interfaces including Ethernet, Wi-Fi, or any number of other physical and data link standard interfaces. In the case where the user need only do operations on a standalone single machine, the network interface 212 is optional.

### Client-Server/Multi-Tier

Client 202 may communicate to a remote storage 214 or a server 216. Server 216 is any computing device that may participate in a network. The network may be, without limitation, a local area network (“LAN”), a virtual private network (“VPN”), a cellular network, or the Internet. The client network interface 212 may ultimately connect remote networked storage 214, or to server 216 via server network interface 218. Server network interface 218 may be one or more network interfaces as described with respect to client network interface 212.

Server 216 also has a processor 220 and memory 222. As per the preceding discussion regarding client device 202, memory 222 is any computer-readable media including both computer storage media and communication media.

In particular, memory 222 stores software which may include an application 224 and/or an operating system 226. Memory 218 may also store applications 224 that may include without limitation, an application server and a database management system. In this way, client device 202 may be configured with an application server and data management system to support a multi-tier configuration.

Server 216 may include a data store 228 accessed by the data management system. The data store 228 may be configured as a relational database, an object-oriented database, a NoSQL database, and/or a columnar database, or any configuration to support scalable persistence.

### Cloud

The server 216 need not be on site or operated by the client enterprise. The server 216 may be hosted in the Internet on a cloud installation 230. The cloud installation 230 may represent a plurality of disaggregated servers which provide virtual web application server 232 functionality and virtual database 234 functionality. Cloud 230 processing services 232 and/or data storage services 234 may be made accessible via cloud infrastructure 236. Cloud infrastructure 236 not only provides access to cloud services 232, 234 but also billing services. Cloud infrastructure 236 may provide additional service abstractions such as Platform as a Service (“PAAS”), Infrastructure as a Service (“IAAS”), and Software as a Service (“SAAS”).

Separating True Reads from Erroneous Reads

DNA sequencing and analysis is sensitive to introduced errors. An exact match overlap of 60 base pairs or higher in reads are needed to achieve more than 95% specificity in assembling human sequences. Convention high fidelity NGS technology yields a base substitution error rate of ˜0.2% per base. Yet this is not sufficient for Anchor Assembly and related techniques. In the cases of a 100 base pair read, the probability of an error occurring if there is a ˜0.2% per base error rate is 18%. In the case where 60 base pair exact match overlap is needed, ˜21% of true read overlaps would be lost due to sequence error.

To reduce the error rate in reads significantly, FIG. 3 is a flow chart 300 of a statistical technique to separate true reads from erroneous reads. FIG. 4 is a frequency distribution chart 400 in the context of separating true reads from erroneous reads.

In block 302, a set of reads from a DNA sample are received. Typically reads come in the form of a text file containing base pair strings. The text files may be read, parsed and stored either in working memory or in a database.

In block 304, each of the received reads is k-Merized to some preset or received value k. Specifically, for each read, the constituent k-Mers for a textual representation of a read are generated.

In order to make a determination of whether a read is true or erroneous, a total quality score for the tread read may be based on the quality scores of individual constituent k-Mers. Accordingly, in block 306, for each k-Mer, a quality score is assigned, based at least on the probability that an error exists in that k-Mer. One potential technique to determine the probability of error in a k-Mer is the Phred base quality score. Given the probability of error pᵢ for a base i in a k-Mer, the k-Mer quality score S may be calculated as:

S=−10 log 10(Πᵢ₌₁^{k}pᵢ)

In block 308, the k-Mers resulting in the k-Merization of the received reads may be collected into k-Mer categories comprised of each set of identical k-Mers. Specifically, there will be duplicate k-Mers generated. Thus the set of unique k-Mers constitutes the set of k-Mer categories.

In block 310, a total quality score for each k-Mer category based at least on the quality score of the component k-Mers in that respective k-Mer category. Typically this may be done by performing a count of k-Mer instances in the k-Mer category and/or performing a sum of the quality scores of each k-Mer instance in the k-Mer category. Other statistical calculations may be applied as well.

In block 312, a distribution of k-Mer categories by total quality score is generated. FIG. 4 is an example distribution chart 400. As would be expected, the k-Mer categories should fall roughly into a pattern of a known distribution function. Specifically, because a k-Mer category is either part of a true read, or part of an erroneous read, it is expected that a bimodal distribution of some sort, for example a Poisson distribution. It is expected that true reads to follow the distribution. However, low quality k-Mer categories are expected to have low total quality scores and to be less frequent. Specifically an error is unlikely to replicate itself in the same way on different reads an therefore is less likely to occur. Accordingly, it is expected that those k-Mer categories to contribute to the spike of k-Mer categories to the right of distribution chart 400.

It is to be observed that while frequency counts are simplest to implement, using only counts loses the information available in the k-Mer quality counts. But by using sums, or otherwise weighting by the individual k-Mer quality scores, erroneous k-Mers are likely to be represented to the far right of the distribution. Accordingly, use of quality information for the constituent k-Mers is an improvement over frequency counts.

Turning back to FIG. 3, in block 314 a threshold total quality score is identified. Specifically, the threshold total quality score cuts off the spike of low quality erroneous k-Mers to the right of the distribution. To the left of the threshold, the k-Mer distribution is to match a known expected distribution. If it does not, the data is interpreted to have some sort of systemic error, and the process is halted without separation of true reads and erroneous reads.

However, below the threshold, the k-Mer distribution is not expected to match a known distribution (other than a spike). In block 316, k-Mer categories with a total quality score greater than the identified quality score are selected as true k-Mers.

### Correcting Errors in Reads

Upon separating erroneous k-Mers from true k-Mers, it may be desirable to correct the erroneous k-Mers. Recall that quality scores may be summed. Accordingly omitting the erroneous k-Mers without corrections, can materially change the weighting of the true k-Mers.

Correction is performed by generating a de Bruijn graph of the true k-Mers and finding the best match of the erroneous k-Mers to the true k-Mers. Upon finding the best match, the erroneous base pairs are changed thereby correcting the erroneous k-Mer into a true k-Mer. FIG. 5 is a diagram of a de Bruijn graph 500 with two paths 502 and 504 and illustrates a determination of a best match.

Path 502 is comprised of k-Mers 1, 2, 3, 4, 5, 6, 7 and 8. Path 504 is comprised of k-Mers 1, 2, 3′, 4′, 5′, 6′, 7′ and 8.

Section 506 shows the comparison of the erroneous sequence AGGTACTCCAG against path 502. Under each base pair, there is a quality score, for example a score deriving from a Phred score, in the event a base pair in the erroneous sequence is substituted for the base pair in path 502. As can be seen there are two potential base substitutions: the third base pair substitution G to C with a quality score of 30, and the sixth base pair substitution C to G with a quality score of 20. Adding the two quality scores yields a read correction score of 50.

Similarly, section 508 shows a comparison of the erroneous sequence AGGTACTCCAG against path 504. Here, there are two potential base substitutions: the third base pair substitution G to C with a quality score of 30, and the seventh base pair substitution T to C with a quality score of 30. Adding the two quality scores yields a read correction score of 60.

Since path 504 yields a higher read correction score of 60, path 504 is selected as being the best match.

This aforementioned process is shown in FIG. 6 as flow chart 600. In block 602, a set of reads is received from a DNA sample and in block 604, the received reads are separated into true reads and erroneous reads. True reads are comprised of true k-Mers as detected and described with respect to FIGS. 3 and 4 above.

In block 606, component k-Mers are generated from at least one true read and in block 608, quality scores for each k-Mer are calculated. As mentioned above, the Phred quality score or one of its variants may be used to calculated a quality score. Note that block 606 and/or 608 may be skipped if the k-Mers from the true read and/or the quality scores have already been generated in determining whether the read is a true read. In block 610, the k-Mers from the at least one true or erroneous read are used to generated a de Bruijn graph as exemplified in FIG. 5.

In block 612, the k-Mers from the at least one erroneous read are generated. As with the true read, block 612 may be skipped if the k-Mers for the erroneous read have already been generated in determining whether the read was a true or erroneous read.

In block 614, a k-Mer in the erroneous read is matched to a k-Mer in the true k-Mers in the de Bruijn graph. A predetermined number of base pairs is generally set to determine whether there is a match sufficient to give confidence in the match. Base pair matches of 60 or more are typical. Ideally base pair matches also are unique and non-repeating. In one embodiment, the search for a match is performed via an A* search on the de Bruijn graph.

K-Mer matches may be in middle of the sequence. If the k-Mer match is in the middle of the sequence, then the traversal of the graph proceeds in both directions when subsequently calculating read correction scores as described below.

If a sufficient match cannot be determined, then the process terminates as unable to identify a correction.

In block 616 the matching k-Mer in the de Bruijn graph is aligned with the k-Mer from the at least one erroneous read. Specifically, the base pairs identified during the matching in block 614 are aligned.

In block 618, a read correction score is calculated by traversing each path of the true k-Mers in the de Bruijn graph that includes the matching k-Mer. If the matching k-Mer is in the middle of the graph, then the graph traversal is performed in both directions.

In block 620, for each path, as the graph is traversed, potential base pair substitutions are detected. If a substitution is detected, the corrected score for that base pair is summed. After the traversals of each path are completed, each path will have a total read correction score associated with it.

In block 622, the path with the greatest read correction score is selected as representing the read correction with the highest confidence. Thus, the path corresponds to the base pair substitutions recommended in order to correct the erroneous k-Mer. A corrected read may then be constituted from corrected k-Mers.

### Anchored Assembly

After a set of true k-Mers has been prepared, the reads comprised of true k-Mers may then be identified as true reads. The true reads are then ready for reassembly. As previously mentioned, conventional assembly techniques either lose large and/or complex structural variants or are computationally impractical and/or prohibitively expensive. Accordingly, this section will describe Anchored Assembly with respect to FIGS. 7, 8 and 9.

Anchored Assembly makes use of a weighted read overlap graph where the edges between two nodes in the graph are populated with confidence weights corresponding to the confidence that the two nodes are attached. FIG. 7 is a diagram of a simple read overlap graph 700 that shows an exemplary process to calculate confidence weights.

The graph 700 represents three reads R1 702, R2 704, and R3 706. Note that R1 702 overlaps R2 704 by 8 sequential base pairs. Accordingly, the edge representing the overlap link between R1 702 and R2 704 is populated with a confidence score based on the overlap, in this case 8. Similarly, the edge representing the overlap link between R2 704 and R3 706 is populated with a confidence score based on the overlap in this case 7.

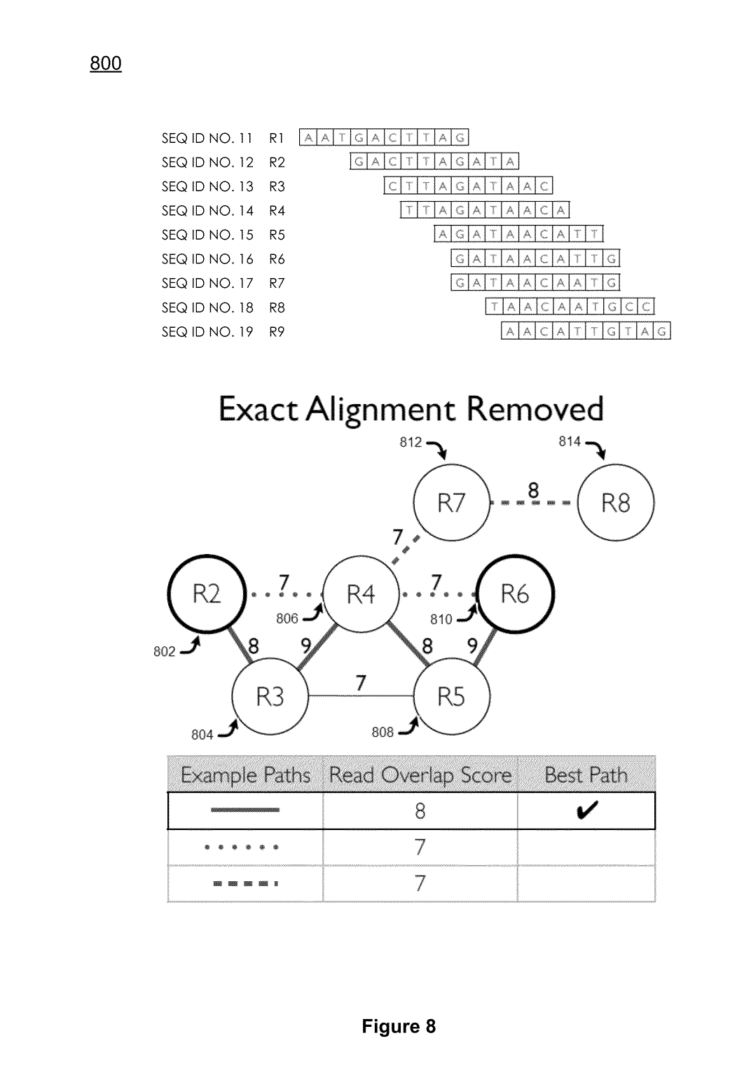

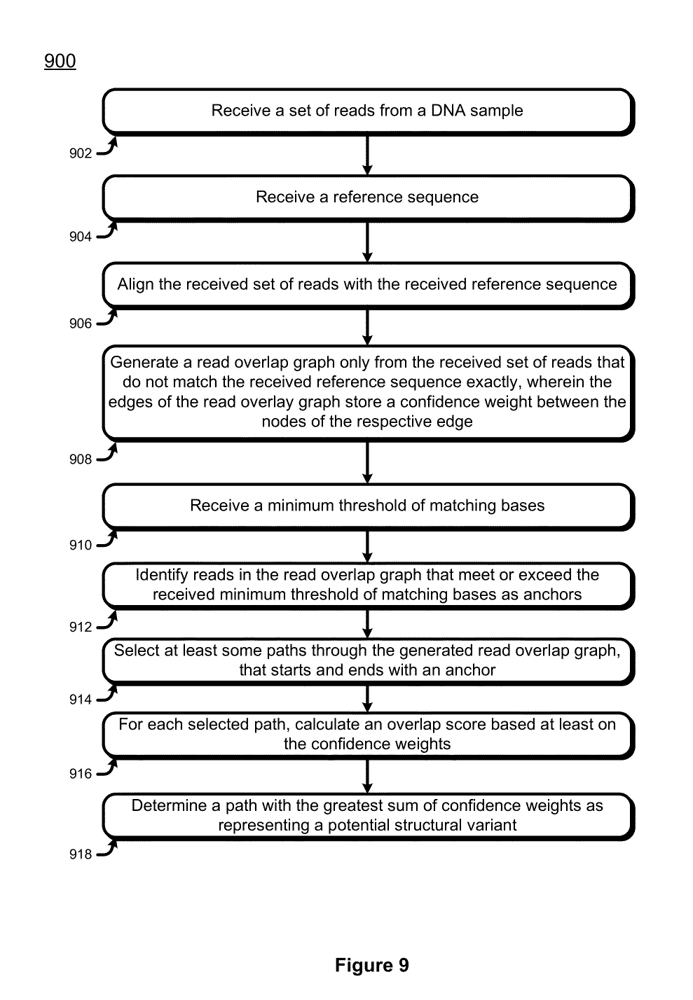

FIG. 8 is another read overlap graph 800 used in conjunction with the FIG. 9 and its flow chart 900 for Anchored Assembly. Specifically, graph 800 is comprised of seven reads without exact alignment: R2 802, R3 804, R4 806, R5 808, R6 810, R7 812 and R8 814.

Turning to FIG. 9, flow chart 900 illustrates different phases of Anchored Assembly. First the exact matches to a reference sequence are eliminated, thereby eliminating read combinations from analysis and thereby greatly reducing the computation resources to be used. Second, anchor nodes corresponding to anchor reads are identified. Third, potential structural variants are identified using the anchors and filtered. Finally the potential structural variants are validated.

Elimination of exact read matches with respect to a reference sequence starts with receiving a set of reads from a DNA sample 902, and receiving a reference sequence 904.

In block 906, the received reads are aligned with the received reference sequence. Reads that have exact matches, specifically reads where all base pairs are sequentially the same as in the reference sequence are removed. This block stems from the presumption that in Anchored Analysis, unknown structured variants are being searched for. Since it is unlikely that structured variants, let alone unknown structured variants are in the reference sequence, exact matches need not be analyzed.

In block 908, the reads that do not match the reference assembly exactly are used to construct a read overlap graph as shown in FIG. 8, item 800. The read overlap graph includes the confidence weights as described with respect to FIG. 7.

Once the read overlap graph has been constructed, anchor nodes may then be identified. Since there are no longer any reads with exact matches, in block 910 a minimum threshold of matching base pairs to determine whether bases match is received

In block 912, reads that meet or exceed the minimum threshold of matching base pairs are identified as anchors. Alternatively, an A* search may be used to identify best matches satisfying the minimum threshold.

Once anchors have been identified, paths between the anchors constitute potential structural variants. However, not all potential structural variants are to be surfaced to a user. Specifically, potential structural variants are first filtered 914 to determine whether computational resources should be expended on computing an overlap score for the potential structural variant's path. If the filter is passed, then an overlap score for the potential structural variant's path is computed.

By way of example, in block 914, the filtering may be implemented by receiving a coverage depth threshold, computing the coverage depth for each path, and then selecting paths that meet or exceed the coverage depth threshold as paths to calculate overlap scores.

In block 916, the paths selected in block 914 have their respective overlap scores calculated. The overlap score may be calculated by traversing the path and summing the confidence weights on the nodes along the path.

In block 918, the path with the greatest overlap score, i.e. the greatest sum of confidence weights may be selected as representing a potential structural variant to be surfaced to a user.

Upon receiving a surfaced potential structural variant, a user will desire to validate the potential structural variant 920. Validation may be performed several ways depending on the distance of the anchors.

If the anchors are relatively close, or within a predetermined threshold distance, and are oriented correctly, an edit count may be used to validate the potential structural variant. Example edits are insertions of base pairs and deletions of base pairs. The presumption is that the least number of edits to transform the reference sequence into the potential structural variant is most likely correct. Accordingly, to perform this process, the portion of the received reference sequence corresponding to the portion of the generated read overlap graph between the anchors is selected. The minimal number of edits to transform the selection of the received reference sequence to the potential structural variant is then counted. The counted minimal number of edits are then reported as detected structural variant, exported in Variant Call Format (“VCF”) or other format.

If the anchors are not within a predetermined threshold distance, or are not oriented accordingly, an alternative reporting of the potential structural variant is to identify the simplest representation of the path, and then reporting the simplest representation of the path as the structural variant. One potential way to obtain the simplest representation is to perform a multiple sequence Smith-Waterman local sequence alignment check. Again, the structural variant may be exported in VCF or other format.

### Multi-Sample Differential Variation Detection

The aforementioned techniques may be used alone or in combination to perform various use cases. One example is to perform multi-sample difference variation detection. Specifically, given a target DNA dataset and a second DNA dataset (“subtraction dataset”), i.e. multiple samples, it may be desirable to detect structural variations that are in the target dataset but not the subtraction dataset. FIG. 10 provides an illustration 1000 of an exemplary process.

Specifically a target dataset 1002 is received and a subtraction dataset 1004 is received, for example, by a receiving software component stored in the memory of a computer. Note that the subtraction dataset 1004 may be comprised of a pool of different DNA sources, potentially different subjects and/or individuals.

The target dataset 1002 may be searched for structural variants 1006 (1), 1006 (2), potentially via Anchored Assembly, by a searching software component stored in the memory of a computer. Anchored Assembly is described above with respect to FIGS. 7, 8 and 9. Alternatively, searching may be performed on a dataset converted to a Prefix Burroughs-Wheeler transform or similar transform.

A particular structural variant, 1006 (1) or 1006 (2), is used to generate its constituent k-Mers 1008 (1) or 1008 (2) (respectively), via a k-Merization software component stored in the memory of a computer. K-Merization is described above.

That structural variant's respective k-Mers 1008 (1) or 1008 (2) are then compared to the constituent k-Mers 1010 of the subtraction dataset 1004. Comparison may be a k-Mer set comparison software component stored in the memory of a computer. The comparisons may include any set operation such as union, join, intersection, and difference, to name a few.

Analysis of the comparisons may be performed via an analytical software component stored in the memory of a computer, and may result in an analytical conclusion. The analytical software component may perform statistical operations including calculating the statistical confidence, or likely degree of error of a conclusion by the analytical software component.

An example of an analytical conclusion is in the context of multi-sample differential variant detection. Here, if all the structural variant's constituent k-Mers 1008 (1) are in the k-Mers 1010 of the subtraction dataset 1004, then the structural variant 1006 (1) is deemed to be in the subtraction dataset 1004. Otherwise, if at least some of the structural variant's constituent k-Mers 1008 (2) are not in the k-Mers 1010 of the subtraction dataset 1004, then the structural variant 1006 (2) is deemed not to be in the subtraction dataset 1004.

Additional reporting may be performed via a reporting software component in the memory of a computer. Reporting may include provision of graphical output including charts, read DNA sequences and k-Mer and/or de Bruijn graphs.

FIG. 11 provides a flow chart 1100 of the process. In block 1102, a target DNA dataset comprising a set of reads from a target is received. In block 1104, the reads comprising the target DNA dataset are used to generate a set of k-Mers. This may be accomplished using the k-Merization process described above.

Similarly in block 1106, a subtraction DNA dataset comprising a set of reads is received. In block 1108, the subtraction DNA dataset is used to generate a set of k-Mers, again via the k-Merization process described above.

In block 1110, a structural variant is detected from the k-Mers generated from the target DNA dataset, potentially via Anchor Assembly.

In block 1112, the detected structural variant is used to generate a set of k-Mers of the structural variant. Note that if the structural variant's k-Mers already exist, for example, from performing Anchor Assembly, then block 1112 may be skipped.

In block 1114, each k-Mer generated from the structural variant is searched for in the k-Mers generated from the subtraction dataset. In block 1116, upon determining that at least one k-Mer generated from the structural variant is not in the set of k-Mers generated from the subtraction dataset, it may be reported that the structural variant is not in the subtraction dataset.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method to detect a variation existing in a target DNA dataset but not existing in a subtraction DNA dataset, the method comprising:
receiving the target DNA dataset comprising a set of reads from a target;
generating a set of k-Mers from the reads in the received target DNA dataset;
receiving the subtraction DNA dataset comprising a set of reads;
generating a set of k-Mers from the reads in the received subtraction DNA dataset;
detecting at least one structural variant from the k-Mers generated from the target DNA dataset;
generating a set of k-Mers from the at least one structural variant;
for each k-Mer generated from the at least one structural variant, determining whether the k-Mer is in the set of k-Mers generated from the subtraction DNA dataset; and
upon determining that at least one k-Mer generated from the at least one structural variant is not in the set of k-Mers generated from the subtraction DNA dataset structural variant, reporting the structural variant is not in the subtraction DNA dataset.

2. The method of claim 1, wherein the subtraction DNA dataset is a pooled DNA dataset.

3. The method of claim 2, wherein the pooled DNA dataset includes DNA from different subjects.

4. The method of claim 1, further comprising filtering the set of k-Mers generated from the received subtraction DNA dataset.

5. The method of claim 4, wherein the filtering the set of k-Mers generated from the received subtraction DNA dataset comprises:
collecting the k-Mers generated from the received subtraction DNA dataset into k-Mer categories comprised of each set of identical k-Mers;
calculating a total quality score for each k-Mer category of a plurality of k-Mer categories based at least on a quality score of component k-Mers in that respective k-Mer category;
generating a distribution of total quality scores of the k-Mer categories;
identifying a threshold total quality score; and
removing, from the set of k-Mers generated from the reads in the received subtraction DNA dataset, all reads over the identified threshold total quality score.

6. The method of claim 5, wherein the identifying a threshold total quality score comprises:
determining the total quality score wherein a frequency distribution of the quality scores matches a known distribution model above a threshold frequency; and
selecting the determined total quality score as a threshold total quality score.

7. The method of claim 6, wherein the known distribution model is a bimodal distribution model.

8. A system to perform set analysis of DNA datasets, comprising:
a processor;
a memory communicatively coupled to the processor;
a receiving software component, stored in the memory, configured to receive a first DNA dataset and a second DNA dataset;
a structured variant search software component, stored in the memory, configured to search for structured variants in a given DNA dataset;
a k-Merization software component, stored in the memory, configured to create a set of constituent k-Mers of a given DNA dataset; and
a k-Mer set comparison software component, stored in the memory, configured to perform at least one set operation between a first k-Mer set created by the k-Merization software component operating on the first DNA dataset and a second k-Mer set created by the k-Merization software component operating on the second DNA dataset to provide a result of the at least one set operation.

9. The system of claim 8, further comprising:
an analytics software component, stored in the memory, configured to analyze the result of the at least one set operation of the k-Mer set comparison software component to provide a conclusion.

10. The system of claim 9, further comprising:
a reporting software component, stored in the memory, configured to output the at least one result of the k-Merization software component or at least one conclusion of the analytics software component, or both.

11. The system of claim 10, wherein an output of the reporting software component comprises at least one statistical calculation.

12. The system of claim 10, wherein the output report comprises any one of a graphical representation, a read DNA sequence, and a de Bruijn graph.

13. The system of claim 8, wherein the first DNA dataset is a target DNA dataset, wherein the second DNA dataset is a subtraction DNA dataset, and wherein the set operation is a difference operation.

14. The system of claim 13, further comprising:
an analytics software component, stored in the memory, configured to perform multi-sample differential variation detection to provide a conclusion as to whether a detected structural variant from the target dataset is in the subtraction dataset.

15. The system of claim 14, wherein the conclusion comprises a statistical calculation indicative of a confidence of the conclusion.

16. The system of claim 14, further comprising:
a reporting software component, stored in the memory, configured to output the conclusion of the multi-sample differential variation detection of the analytics software component.

17. The system of claim 16, wherein the output comprises any one of a graphical representation, a read DNA sequence, and a de Bruijn graph.

18. The system of claim 8, wherein the structured variant search software component is configured to perform a Prefix Burrows-Wheeler Transform.

19. The system of claim 8, wherein the structured variant search software component is configured to perform an Anchored Assembly.

20. A system, comprising:
a processor;
a computer-readable medium, communicatively coupled to the processor, storing computer-readable instructions which, upon execution by the processor, perform operations comprising:
receiving a target DNA dataset comprising a set of reads from a target;
generating a set of k-Mers from the reads in the received target DNA dataset;
receiving a subtraction DNA dataset comprising a set of reads;
generating a set of k-Mers from the reads in the received subtraction DNA dataset;
detecting at least one structural variant from the k-Mers generated from the target DNA dataset;
generating a set of k-Mers from the at least one structural variant;
for each k-Mer generated from the at least one structural variant, determining whether the k-Mer is in the set of k-Mers generated from the subtraction DNA dataset; and
upon determining that at least one k-Mer generated from the at least one structural variant is not in the set of k-Mers generated from the subtraction DNA dataset structural variant, reporting the structural variant is not in the subtraction DNA dataset.


SEQUENCE LISTING (19 sequences)

SEQ ID NO: 1 - DNA, 15 bp, Artificial Sequence
  hypothetical example seqeuence
cttcaggtccatatg

SEQ ID NO: 2 - DNA, 11 bp, Artificial Sequence
  hypothetical example sequence
aggtactccag

SEQ ID NO: 3 - DNA, 11 bp, Artificial Sequence
  hypothetical example sequence
aggtactccag

SEQ ID NO: 4 - DNA, 20 bp, Artificial Sequence
  hypothetical example sequence
ctactaccacccccccccca

SEQ ID NO: 5 - DNA, 32 bp, Artificial Sequence
  hypothetical example sequence
agctgctactagtagtagtcgtcctccaccag

SEQ ID NO: 6 - DNA, 11 bp, Artificial Sequence
  hypothetical example sequence
aggtactccag

SEQ ID NO: 7 - DNA, 11 bp, Artificial Sequence
  hypothetical example sequence
aggtactccag

SEQ ID NO: 8 - DNA, 10 bp, Artificial Sequence
  hypothetical example sequence
taataggcat

SEQ ID NO: 9 - DNA, 10 bp, Artificial Sequence
  hypothetical example sequence
tataataggc

SEQ ID NO: 10 - DNA, 10 bp, Artificial Sequence
  hypothetical example sequence
agatataata

SEQ ID NO: 11 - DNA, 10 bp, Artificial Sequence
  hypothetical example sequence
aatgacttag

SEQ ID NO: 12 - DNA, 10 bp, Artificial Sequence
  hypothetical example sequence
gacttagata

SEQ ID NO: 13 - DNA, 10 bp, Artificial Sequence
  hypothetical example sequence
cttagataac

SEQ ID NO: 14 - DNA, 10 bp, Artificial Sequence
  hypothetical example sequence
ttagataaca

SEQ ID NO: 15 - DNA, 10 bp, Artificial Sequence
  hypothetical example sequence
agataacatt

SEQ ID NO: 16 - DNA, 10 bp, Artificial Sequence
  hypothetical example sequence
gataacattg

SEQ ID NO: 17 - DNA, 10 bp, Artificial Sequence
  hypothetical example sequence
gataacaatg

SEQ ID NO: 18 - DNA, 10 bp, Artificial Sequence
  hypothetical example sequence
taacaatgcc

SEQ ID NO: 19 - DNA, 10 bp, Artificial Sequence
  hypothetical example sequence
aacattgtag